(19) United States
(12) Patent Application Publication
(10) Pub. No.: US 2007/0058943 A1
(43) Pub. Date: Mar. 15, 2007

(54) System, method and apparatus for rapid mass production of content-inclusive physical media

(75) Inventors: David Blanchard, West New York, NJ (US); Rich Isaacson, Tarrytown, NY (US); Sami Valkonen, Stamford, CT (US); Jacob Walker, Boston, MA (US)

Correspondence Address: CHALKER FLORES, LLP, 2711 LBJ FRWY, Suite 1036, DALLAS, TX, 75234, US

(73) Assignee: DiscLive, Inc., New York, NY (US)

(21) Appl. No.: 10/986,558

(22) Filed: Nov. 10, 2004

Related U.S. Application Data
(60) Provisional application No. 60/518,330, filed on Nov. 10, 2003.

(51) Int. Cl. H04N 7/00

(52) U.S. Cl. 386/96

(57) ABSTRACT

A method for recording audio and/or video of an event on a plurality of recordable media comprises the steps of capturing audio and/or video at the event from at least one pickup to a recording station, transferring the captured audio and/or video from the recording station to a file server for storage, copying the captured audio and/or video from the file server to at least one computer, and recording the audio and/or video from the at least one computer to the plurality of recordable media. The captured audio and/or video may be separated into content files representing songs or topics. The captured audio and/or video may be copied from one computer to another computer, which may also record to the media. A robotic duplication system may be attached to the computer. The file server is instructed to begin the copying process once all audio and/or video has been captured.

### REFERENCE TO RELATED APPLICATIONS

This application claims priority to U.S. Provisional Patent Application No. 60/518,330 filed Nov. 10, 2003, which is herein incorporated by reference in its entirety.

### FIELD OF THE INVENTION

The present invention relates to the field of content distribution, and more particularly provides a system and method for enabling the capturing, production, mastering, manufacturing and distribution of a plurality of optical discs or other media containing a recording of an event within minutes of the end of the event at a scale previously unachievable.

### BACKGROUND OF THE INVENTION

The most prevalent media for transporting music, video, and other content are various forms of optical compact discs (also referred to as “CDs”). The media stored on a disc is typically formatted to comply with industry standards. There are several optical disc standards, including a “Red Book” standard for audio compact discs, a “White Book” standard for video compact discs, a “Yellow Book” standard for computer data, a “Blue Book” standard for enhanced audio compact discs, an “Orange Book” standard for recordable compact discs, a “Green Book” standard for interactive compact discs, a “Purple Book” standard for double density compact discs, a “Photo CD” standard for photographs on compact disc, and the like.

Optical discs are preferred today because of their relatively small size and large storage capacity. Such a large storage capacity is advantageous because one large or, alternatively, many small content files may be stored on a single medium. The length or size of content that may be stored on a single medium can vary based on several factors, including the content type, content file structure, sampling rate, resolution, compression type, and the like. For example, a standard audio CD can store up to eighty minutes worth of music because of the content file structure and limited audio compression adopted as part of the applicable Red Book standard. A CD storage capacity of eighty minutes corresponds to approximately 700 MB of data.

Event spectators often desire a copy of a recording of that event. Preferably, the recorded media is available within moments after the event. Mass production of content-laden media, such as audio CDs, is a resource intensive process. A number of conventional systems are capable of duplicating a few optical discs in rapid fashion, utilizing both automated and non-automated equipment. Any of these systems, when used in parallel, could be used to mass-produce optical discs at an event location. However, linking these conventional systems cannot replicate the rapid duplication in smaller systems. In other words, the conventional systems do not allow users to increase throughput without introducing bottlenecks into the system that would delay the production of a first optical disc that would be available for sale at the event location. These bottlenecks become a crucial disabling factor when desiring the production of mass quantities of optical discs within moments after the conclusion of an event.

Conventional optical disc manufacturing requires the creation of several “master” copies, which are then used to initiate duplication on stand-alone optical disc duplicators. In fact, most optical disc manufacturing occurs at large factories because the equipment necessary to automate high-volume production at a cost effective level is large and can be very expensive. Musical artists, comedians, speakers, and other performers are significantly limited in their ability to provide customers with media containing a recording of an event within minutes of the end of the event.

One conventional recording system is exemplified in a manual system illustrated in FIG. 1. The system employs a plurality of microphones and instrument pick-ups 105 on stage 100. These microphones are plugged into a sound-board 120, which controls the sound levels and other attributes of sounds played through a venue's public address (“PA”) system. Additional microphones 110 are located in the audience to capture spectator sounds during the event. The spectator sounds are fed from the additional microphones 110 into sound-board 120, although they are not broadcast onto the PA system. Instead, a stereo feed mixing the audio from microphones and pick-ups 105 as well as microphones 110 are fed to a recording station 130.

At the recording station 130, an audio engineer may mix and manage the event recording using a computer or other device. When the event is over, this information is written to a Master CD Duplicator 140, which is capable of producing a number of master optical discs, limited by the capacity of the duplication equipment. A human must then transfer the master optical discs into other, stand-alone optical disc duplication systems 150, also referred to herein as “Tier 1 CD Duplicators.” It should be noted that the Tier 1 CD Duplicators 150 are not physically or electronically connected to the rest of the system, resulting in necessary human interaction for transferring the master optical discs from Master CD Duplicator 140 to the Tier 1 CD Duplicators 150. This transfer process creates a significant bottleneck in the system.

Tier 1 CD Duplicators 150 duplicate the master optical disc content onto additional CDs. These additional CDs are fed into Tier 2 CD Duplicators 170 which begin to produce another set of optical disc recordings of the event. Upon the completion of recording in the Tier 2 CD Duplicator 170, this set of recordings form the Tier 2 CD Duplicators 170 becomes a first batch of CDs that may be offered for sale. This process may need to be repeated to obtain a desired amount of CDs.

Typically, each of the Tier 1 CD Duplicators 150 and the Tier 2 CD Duplicators 170 contain one optical media drive that can read the master recording and save it to a hard drive. The Tier 1 CD Duplicators 150 and the Tier 2 CD Duplicators 170 are also capable of synchronously and repetitively producing copies of a master recording onto blank optical media.

Although the conventional system may be sufficient for limited production runs, the approach requires human involvement in loading master optical discs to each duplication system. This bottlenecks the production process, slowing the output such that it frequently takes eight to ten minutes per “batch” of CDs. Clearly, this makes rapid mass production, e.g., production on the scale of a hundred or more discs within twenty minutes of the end of an event, very difficult or impossible. Furthermore, consumer-grade equipment is typically used in the conventional system approach, thus requiring significant capital equipment and limiting larger scale production.

The conventional approach also has other drawbacks. For example, optical disc duplication is prone to a high failure and error rate. Each Tier 1 or Tier 2 CD Duplicator typically contains a plurality of consumer-grade optical disc drive recorders, i.e., burners, that are synchronously connected. Because each duplicator acts synchronously, if one of the discs being recorded contains an error, the equipment will spend time trying to detect and fix the error. As a result, the other burners in the Tier 1 or Tier 2 CD Duplicator will stop duplicating.

Alternatively, the conventional system may not detect an error at all. If this occurs while the duplicator is producing an optical disc that will be used as a master in another system, such as in Master CD Duplicator 140 or Tier 1 CD Duplicator 150, this error could be exponentially replicated without knowledge throughout the system. Furthermore, each time human involvement is required, e.g., every disc produced on the conventional system, additional error opportunities are created. For example, an event frequently requires the duplication of more than one disc (i.e., a two or three disc set). When this occurs, each person responsible for loading and unloading the machines must keep track of which disc they are supposed to be recording and ensure that they are loading the proper media into the drive. This grows increasingly difficult as the number of duplicators increases.

The conventional system also requires the attendants to create master discs for each Tier 2 duplication system, causing a significant lag between the time an event ends and the time the first non-master disc produced is available for sale. This time lag becomes fatal in situations requiring mass production of these discs as patrons are typically willing to wait only a few minutes for a recording of the event.

### SUMMARY OF THE INVENTION

The present invention provides a system, method and apparatus for rapid mass production of content-inclusive media that substantially obviates one or more of the problems due to limitations and disadvantages of the related art. For example, the present invention provides a scalable system through which content-laden media can be easily created, facilitates rapid creation of a plurality of content-laden media, and automates many of the manual processes associated with content-laden media creation. The present invention can easily be installed within a trailer that allows the system to be mobile and travel with the event or move to different venues. For example, nearly 200 robotic duplication systems can be housed in a 26′ trailer that can produce up to 800 CDs in less than twenty minutes, with the first CDs being produced and ready for sale or delivery to the public within minutes of the end of the event (e.g., concert, play, seminar, show, speech, meeting, conference, competition, demonstration, presentation, public appearance, opening, press conference, sports or athletics event, or any other situation where it may be desirable to make a recording of it, no matter what it is). Moreover, the quality of the recordings is comparable to live event recordings that are subsequently processed and remixed in studios.

Note that the present invention is not limited to the recording CDs and may include alternative optical disc media, such as CD-ROM, CD Audio, Enhanced CD, DVD-Audio, DVD-Video, Super Audio CD, and Video CD, and other media known in the art. The present invention will also work with non-optical media, such as compact flash cards, memory sticks, smart media, and other media known in the art, although such technologies may require different robotics and other equipment. Moreover, the present invention can be adapted to reproduce multiple electronic copies of the content and distribute them electronically via a network or other transmission medium. Nevertheless, the core concept remains of disseminating the files from a content creation station to a file server and then to individual PCs to manage the process of writing content to the media or otherwise distributing the content.

Similarly, the present invention is not limited to audio formats and recording audio CDs; any format or content is possible. In one embodiment, video and photos are sent to a video content workstation where the videos are perfected and turned into machine-readable executables or files. The files are then similarly copied to a file server and disseminated to individual duplication PC's. The theory behind the audio concepts applies to video, photographs, multimedia and the like.

In one embodiment, the present invention provides a method for recording an event on a plurality of recordable media comprises the steps of capturing audio and/or video at the event by a recording station, transferring the captured audio and/or video from the recording station to a file server, storing the captured audio and/or video on the file server, and copying the captured audio and/or video onto recordable media at an at least one computer. The captured audio and/or video may be divided into separate content files, wherein each content file may be a song or a topic. The captured audio and/or video may be stored on the at least one computer. The captured audio and/or video are copied from the at least one computer to the recordable media. The at least one computer may have a duplication system attached thereto, such as a robotic duplication system. The captured audio and/or video may be transferred to the Internet. The captured audio and/or video may be copied from the at least one computer to second computer. The file server may be instructed that all audio and/or video has been captured for the recordable media. The at least one computer is then instructed to begin copying the captured audio and/or video.

In an alternative embodiment, the present invention provides a method for recording data on recordable media comprising the steps of receiving the data, transferring the data to a file server; transferring the data to at least one personal computer; commanding the at least one personal computer to copy the data to recordable media. The data may be converted into a .WAV file. The data may be split into at least a first portion and a second portion, wherein at least the first portion is transferred to the file server. The quality of the data to be transferred to the at least one personal computer is checked. The data may be transferred from the at least one personal computer to a second at least one personal computer. A number of media to be created and number of portions for each medium are inputted.

The present invention also provides an apparatus for recording audio and/or video of an event on a plurality of recordable media that includes a recording station that receives an event signal, a file server and at least one computer. The file server is communicably coupled (e.g., direct connection, wireless connection, optical connection, infrared connection or any other device communication means) to the recording station such that it receives the event signal from the recording station and stores the captured audio and/or video. The least one computer is communicably coupled to the file server and receives a copy of the stored event signal from the file server and records the stored event signal from the at least one computer to the plurality of recordable media.

In addition, the present invention provides a system for recording audio and/or video of an event on a plurality of recordable media that includes a mobile transport unit having a recording station, a file server, and at least one computer therein. Note that the mobile transport unit can be a kit, shipping unit, truck, trailer, vehicle, or other such transport means that allows the system to be transported from one location to another with only a reasonable amount of required assembly or setup. The recording station has an interface to receive an event signal from an outside source. The file server is communicably coupled to the recording station such that it receives the event signal from the recording station and stores the captured audio and/or video. The at least one computer is communicably coupled to the file server such that it receives a copy of the stored event signal from the file server and records the stored event signal from the at least one computer to the plurality of recordable media.

Additional features and advantages of the invention will be set forth in the description which follows, and in part will be apparent from the description, or may be learned by practice of the invention. The objectives and other advantages of the invention will be realized and attained by the structure particularly pointed out in the written description as well as the appended drawings. It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention, in which:

FIG. 1 is a block diagram illustrating a prior art CD duplication system;

FIG. 2 is a block diagram illustrating a content-laden media duplication system according to an embodiment of the present invention;

FIG. 3 is a block diagram illustrating a multi-track recording being stored on media;

FIG. 4 is block diagram illustrating the duplication system according to an embodiment of the present invention; and

FIG. 5 is a block diagram illustrating the software components according to an embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. Reference will now be made in detail to the preferred embodiments of the present invention, examples of which are illustrated in the accompanying drawings.

The present invention provides a system, method and apparatus for rapid mass production of content-inclusive media that substantially obviates one or more of the problems due to limitations and disadvantages of the related art. For example, the present invention provides a scalable system through which content-laden media can be easily created, facilitates rapid creation of a plurality of content-laden media, and automates many of the manual processes associated with content-laden media creation. The present invention can easily be installed within a trailer that allows the system to be mobile and travel with the event or move to different venues. For example, nearly 200 robotic duplication systems can be housed in a 26′ trailer that can produce up to 800 CDs in less than twenty minutes, with the first CDs being produced and ready for sale or delivery to the public within minutes of the end of the event (e.g., concert, play, seminar, show, speech, meeting, conference, competition, demonstration, presentation, public appearance, opening, press conference, sports or athletics event, or any other situation where it may be desirable to make a recording of it, no matter what it is). Moreover, the quality of the recordings is comparable to live event recordings that are subsequently processed and remixed in studios.

Note that the present invention is not limited to the recording CDs and may include alternative optical disc media, such as CD-ROM, CD Audio, Enhanced CD, DVD-Audio, DVD-Video, Super Audio CD, and Video CD, and other media known in the art. The present invention will also work with non-optical media, such as compact flash cards, memory sticks, smart media, and other media known in the art, although such technologies may require different robotics and other equipment. Moreover, the present invention can be adapted to reproduce multiple electronic copies of the content and distribute them electronically via a network or other transmission medium. Nevertheless, the core concept remains of disseminating the files from a content creation station to a file server and then to individual PCs to manage the process of writing content to the media or otherwise distributing the content.

Similarly, the present invention is not limited to audio formats and recording audio CDs; any format or content is possible. In one embodiment, video and photos are sent to a video content workstation where the videos are perfected and turned into machine-readable executables or files. The files are then similarly copied to a file server and disseminated to individual duplication PC's. The theory behind the audio concepts applies to video, photographs, multimedia and the like.

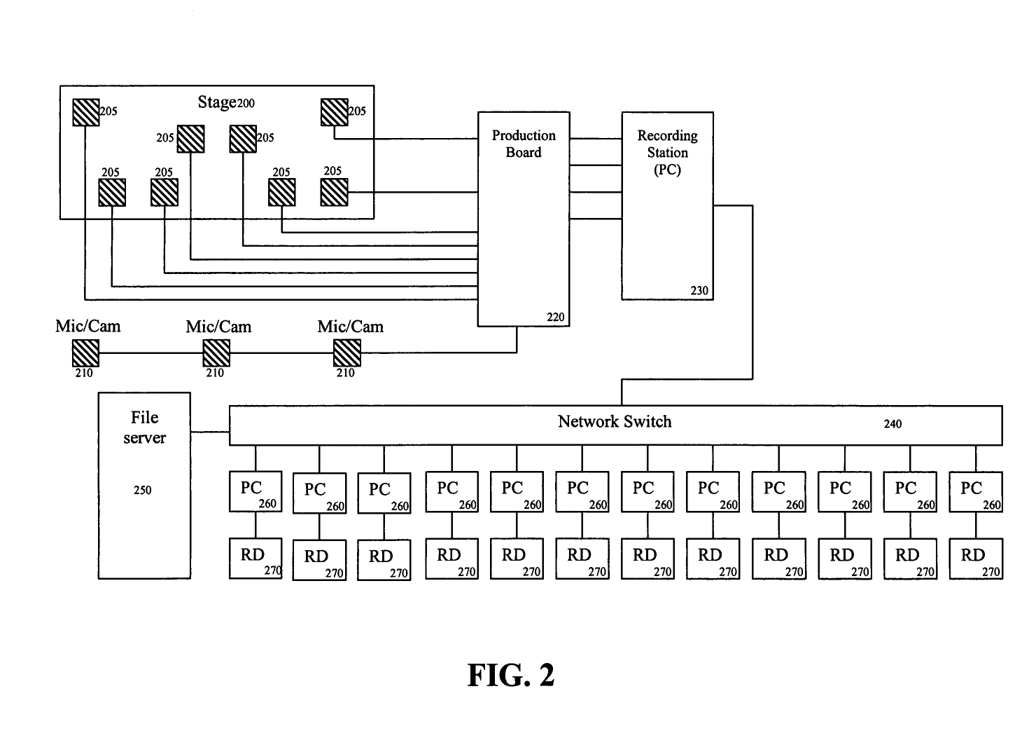

Now referring to FIG. 2, one embodiment of the system of the present invention is illustrated. Because the present invention is typically used in an environment similar to that in which the conventional system is utilized, the basic, event-side aspects of the present invention are similar thereto. As FIG. 2 illustrates, sound and/or images are captured from one or more instrument pick-ups, microphones, and/or cameras 205 (referred to herein as pick-ups 205 for clarity) on stage 200 as an event proceeds. Additionally, cameras and/or microphones 210 (referred to herein as microphones 210 for clarity) may be placed in the audience. The feed from pick-ups 205 and microphones 210 is preferably fed through a main production board 220 at the event to a recording station 230 that preferably features at least one networked computer.

The at least one networked computer (e.g., personal computer, laptop computer, laptop computer, workstation or other suitable processing device) in recording station 230 is preferably used to mix and record the feed from pick-ups 205 and microphones 210. However, the at least one networked computer preferably divides the feed from pick-ups 205 and microphones 210 into a plurality of separate computer content files. For example, without intending to limit the present invention, the at least one networked computer may divide a music event such that each song becomes a separate content file or such that a separate chapter heading is associated with each song, thereby permitting easy navigation to a particular song. Similarly, content files associated with a recorded speech are preferably divided at appropriate intervals, such as by page or by topic. As the feed is divided, separate computer content files are preferably created, and each content file is preferably transferred directly from recording station 130 to a file server 250 through a network switch 240 or other similar device.

File server 250 is preferably a traditional computer (e.g., personal computer, laptop computer, laptop computer, workstation or other suitable processing device) that has been tuned to facilitate rapid content file input/output functionality. Means for performing such tuning under the Microsoft Windows® family of operating systems or the Linux® operating system are well known in the art.

In addition to being stored on file server 250, each content file is also preferably stored on the hard drive of each of a plurality of PCs 260. Note that any reference to a PC can include any processing device that provides the functionality required by the present invention, such as a personal computer, laptop computer, laptop computer, workstation or other suitable processing device. Moreover, the PC is not limited to the design architecture typically associated with PCs and may include equipment manufactured by Apple Corporation or other non-PC compatible manufacture. Each of the plurality of PCs 260 preferably has one or more robotic disc duplication systems 270 attached thereto. Although robotic disc duplication systems are presently preferred, it should be apparent to one skilled in the art that standard duplication systems may be substituted therefor without departing from the spirit or the scope of the invention.

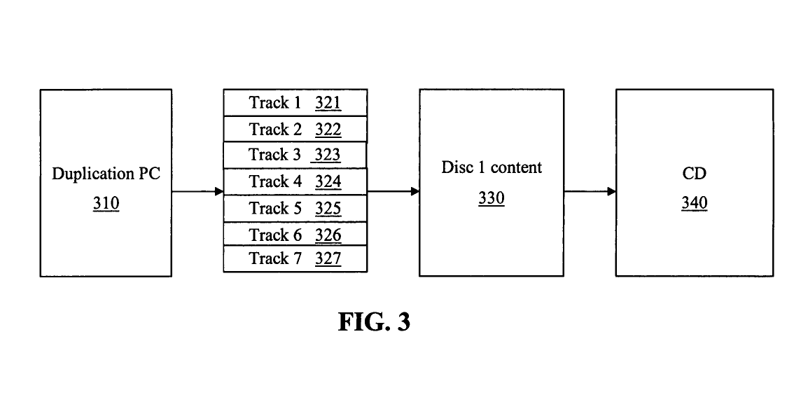

After the final content file to be added to a particular CD is transferred to each of PCs 260, the content files may be combined to create an “image” file as illustrated in FIG. 3, thereby simplifying the CD creation process. In re-assembling the contents of a CD 340, a duplication PC 310 compiles the tracks 321, 322, 323, 324, 325, 326, 327 into an image file 330. Image file 330 is then utilized to record CD 340. Such an image file may meet industry standards, such as, but not limited to, those conventionally referred to as the “Orange Book” standard, “Blue Book” standard, “White Book” standard, “Red Book” standard, “Yellow Book” standard, and the like. Alternatively, an image file may utilize one or more proprietary formats, thereby requiring a specific player to experience the content.

The robotic duplicator is a robotic duplication system, such as an MF DIGITAL duplicator system. Before duplication begins, a series of blank CD-Rs, or other optical media, are placed in a loading slot in the robotic duplication system. When duplication commences, a robotic arm with a laser eye is preprogrammed to move to that slot and pick up one CD-R at a time. The robotic arm grasps the CD-R and transfers the CD-R to a tray of an open CD-ROM (or optical) disc drive. The disc drive closes and the robotic arm continues to load the system. Upon completion of the recording, the disc drive tray opens and the robotic arm picks up the disc from that tray and moves it to a “finished” spindle or to a “rejected” spindle based on the success of the duplication. This process is managed by software running on the duplication PC.

The production board 220, recording station 230, network switch 240, file server 250, PCs 260, and robotic disc duplication systems 270 may be located anywhere. The connection between the microphones 210 and a soundboard to an audio workstation is limited only by the length of cable or wire utilized. The audio workstation is conventionally placed within 300 feet of the rest of the equipment. However, this threshold may be extended through via any high speed file transfer system. In an alternative embodiment of the present invention, recorded audio files can be transferred to the Internet, on a song-by-song or disc-by-disc basis.

The system preferably employs the use of client/server software on each of file server 250, recording station 230, and PCs 260. The client/server software is capable of automating tasks which would otherwise create huge bottlenecks in the production of CDs. For example, without intending to limit the present invention, such software may manage the copying of individual content files from recording station 230 to file server 250 and individual PCs 260. The software can detect and correct any errors that occur during the copying process, and may do so without slowing down the overall system.

The software is preferably also able to leverage the bandwidth on the network by copying content files from one of PCs 260 to one or more other PCs 260 in the event a specific PC 260 is unable to communicate with file server 250, or in the event file server 250 is unable to effectively communicate with the plurality of PCs 260 at the same time. Although such a distributed software architecture is presently preferred, it should be apparent to one skilled in the art that a more centralized software architecture, such as one in which file server 250 acts as not only a file server but manages operation of PCs 260 and retrieves content files from recording station 230, may be substituted therefor without departing from the spirit or the scope of the invention.

Software running on file server 250 is also preferably capable of receiving an instruction from recording station 230 indicating that all content files associated with the event, or at least those to be placed on an individual medium, have been made available. Upon receipt of such a command, file server 250 preferably instructs each of PCs 260 to begin creating discs using the attached robotic disc duplication systems 270. Such a command may be transmitted from recording station 230 to file server 250 and/or PCs 260 through a network socket connection. The communication that the software facilitates allows a single operator to orchestrate the simultaneous, asynchronous creation of tens or even hundreds of individual CDs. In addition, the software makes the system more redundant so that, in the event of many types of system failures, CDs will continue to be produced.

The software running on each of the PCs 260 and the file server 250 preferably allows the present invention to automate many of what would otherwise be manual processes, including, but not limited to, copying content files to each of the PCs 260 and starting the CD creation process on each duplicator 270. By removing the need for human involvement, the custom software can also eliminate the potential for human errors to occur.

Through the architecture of the system, the present invention can not only increase the CD creation throughput as compared to conventional systems, but the architecture also achieves this throughput increase without increasing the delay in the time the first saleable CD is created. The same cannot be said for a manual system, wherein adding additional systems increases throughput in the long run, but creates an additional choke-point whereby human error can occur and additional time is required between the end of an event and the production of the first saleable disc.

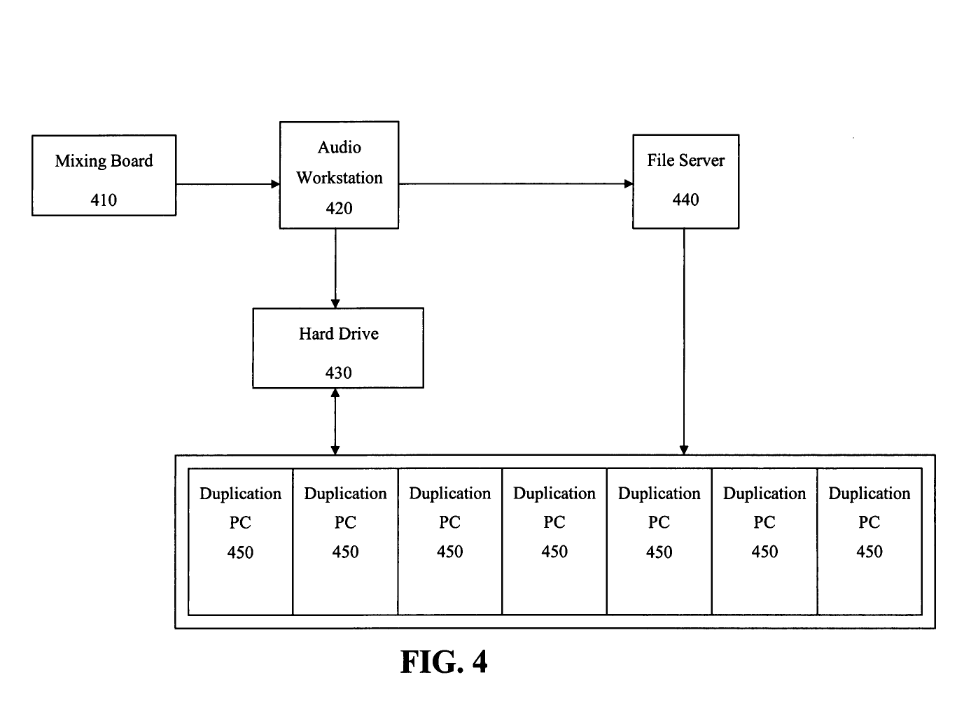

In another embodiment of the present invention shown in FIG. 4, a mixing board 410 mixes the audio for an event audience. A feed of preferably at least four channels are fed from the mixing board to an audio workstation 420 of the present invention. At audio workstation 420, the feed is digitized and recorded on a hard drive 430. As each song is completed, the digitized feed splits the song off as a .WAV file, which can then be transferred to the file server 440. The file is disseminated from the file server 440 to a plurality of individual duplication PCs 450. Each song or event segment is fed from the mixing board 410 to the audio workstation 420, recorded to the hard drive 430, transferred to the file server 440 and disseminated to the individual duplication PCs 450. This process is repeated until there is enough content to create a CD. Once a decision is made to create a CD, the file server 440 issues commands to the individual duplication PCs to begin the duplication process. The command includes information regarding the number of songs or .WAV files on the CD, the location of the songs or files on the hard drive 430, and the number of CDs to be produced. Each individual duplication PC 450 re-assembles the individual files into a coherent disc image, or .ISO file. The individual duplication PCs 450 send instructions to the robotic duplication system and the CD burners to continue pressing images of that .ISO file until is has produced the desired number of CDs. In a situation where an event is longer than the length of a CD, two or more CDs may be used to capture the event. Once a decision is made to create a CD, the process of recording files to hard drive and transferring the files to a file server may be done concurrently with the duplication process, such that the process for creating at least a second CD may progress.

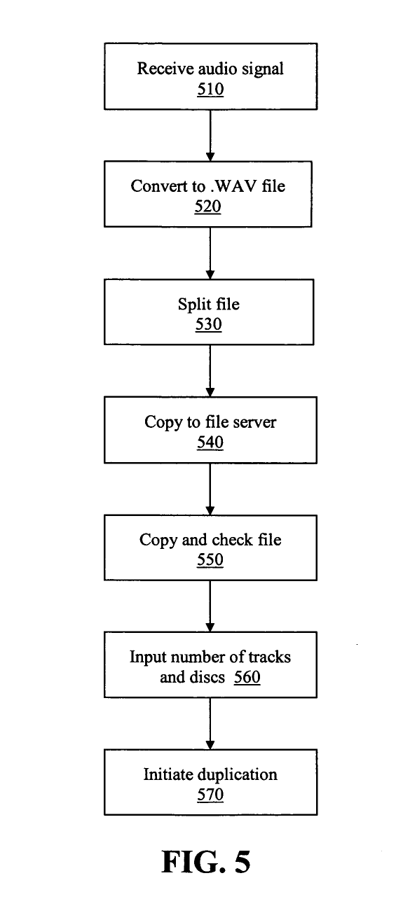

Referring to FIG. 5, a software program comprises two components. A first component transfers the files from an audio workstation to a file server and to a plurality of individual PCs. An audio signal from a mixing board 510 is converted into a .WAV file 520 using audio editing software such as STEINBERG WAVELAB software. The .WAV format is the format associated with audio CDs, although other appropriate formats may be utilized as known in the art. As each song is converted to the .WAV format, a notation is made to divide the file 530 into a separate content file. Once the file is divided, a software program such as TAKECOMMAND from JP SOFTWARE uses a customized script to copy the file to a file server 540. Note that the present invention can be configured to divide the files only after enough content to fill one CD or a specified portion of the recording media has been stored.

A second component, after ensuring completion of the first component, launches and manages the duplication process. The TAKECOMMAND program copies the file from the file server 540 to each duplication PC, or from individual PC to individual PC, and checks the file to ensure the quality and content is as desired in step 550. A program user inputs the number of tracks and number of CDs to be created in step 560. The input 560 further commands the duplication PCs to begin the duplication process. Further software running on each duplication PC accepts the commands and initiates the individual duplication jobs 570. Since each PC operates separately, the PC has no contact or communication with any central program once the job command is issued. This ensures that if one or more PCs fail, the failure is not transferred to the other PCs.

The software interfaces with individual systems. A human user may manually intervene at one or all of the workstations or systems. However, a human component negates the effects of the automation, which eliminates the bottlenecks associated with such manual operation.

As should be apparent to one skilled in the art, the present invention may provide several advantages over the prior art. Such advantages include, but are not limited to, allowing content files to be transferred from recording station to file server and/or PCs even as the event is occurring, rather the conventional systems that transfer the data at the conclusion of the event. This present invention thus provides for faster CD production.

In an alternative embodiment, the recording station can write directly to a CD-ROM, rather than to files located on a hard drive. This master CD-ROM could then be used to duplicate additional CDs utilizing CD duplication equipment that does not need to be connected to a PC. In this embodiment, the file server is not necessary. This system also requires a copy of the master CD for each duplicator. Additionally, any problems with the master CD will translate to the copies thereof.

Recording the file directly to a hard drive and subsequently transferring the file to a file server eliminates the need for many master CDs and any issues regarding the detection of a recording problem. The file server of the present invention mitigates the computer processes and resources used by the audio workstation. Since the copying of files occurs concurrently with the recording of an event, the file server handles the processes of copying files to numerous duplication systems, rather than having an overloaded recording station perform that role.

An advantage of the present invention is that the system architecture eliminates the need for one or more “master” discs. By eliminating the need for master discs, the present invention avoids the potential for the dissemination of errors throughout the duplication system.

By creating CDs from information stored on the hard drive of PCs and the file server, the present invention also facilitates validating the information stored on PCs before recording it on the media. This allows the present invention to insure that each content file is exactly the same on each of PCs, and to validate this against one or more reference content files, such as the content file or content files on the file server. Content files may be validated through a variety of means, including, but not limited to, through computing a “checksum” for each content file.

There are different types of checksum checks that can be performed on each file, as well as programs which can analyze each file byte-for-byte. The resources of doing a checksum on each file are much less than those required for a byte-by-byte analysis, and the results are essentially the same. The methods of comparing files for similarity and analyzing audio content may be performed by any such method known to one of ordinary skill in the art. However, methods that are resource intensive are preferably avoided as the only necessary component is a checksum analysis.

Although creation of an image file is preferred, it should be apparent to one skilled in the art that an image file is not necessary, and that alternative recording means may be utilized without departing from the spirit or the scope of the invention. By way of example, without intending to limit the present invention, it may be preferable to sell CDs wherein the content is stored on a non-optical medium. In the event such non-optical media are used, a disc image may not be necessary.

Still another advantage of the present invention over other CD creation systems is that the coupling of electronic content file delivery with robotic duplication equipment means that no human involvement is required for the loading and unloading of each piece of duplicated media. A human operator need only intervene to begin the process of duplication by loading in the required amount of blank media into a robotic duplicator.

Yet another advantage of the present invention is that, because the content files are copied to each system during the event itself, a significant amount of time is saved between the end of the event and the production of the first media available for distribution. As a result, customers can purchase a CD much faster than when conventional production techniques are employed.

Utilizing the present invention, each individual PC has an audio copy of approximately ninety percent of the event. To begin the duplication process, the individual PCs need the last song, approximately the last ten percent of the event. The individual PCs then re-assemble the segments into a whole image of a CD, as compared to the conventional systems of copying and analyzing an entire CD once the event is completed. The time utilized to copy the last ten percent of the event and re-assembling into a coherent image is approximately the equivalent of the conventional systems transferring the data to the second and third level of duplicators to begin production. In other words, the system of the present invention is may be completed when the conventional system is just beginning the duplication process.

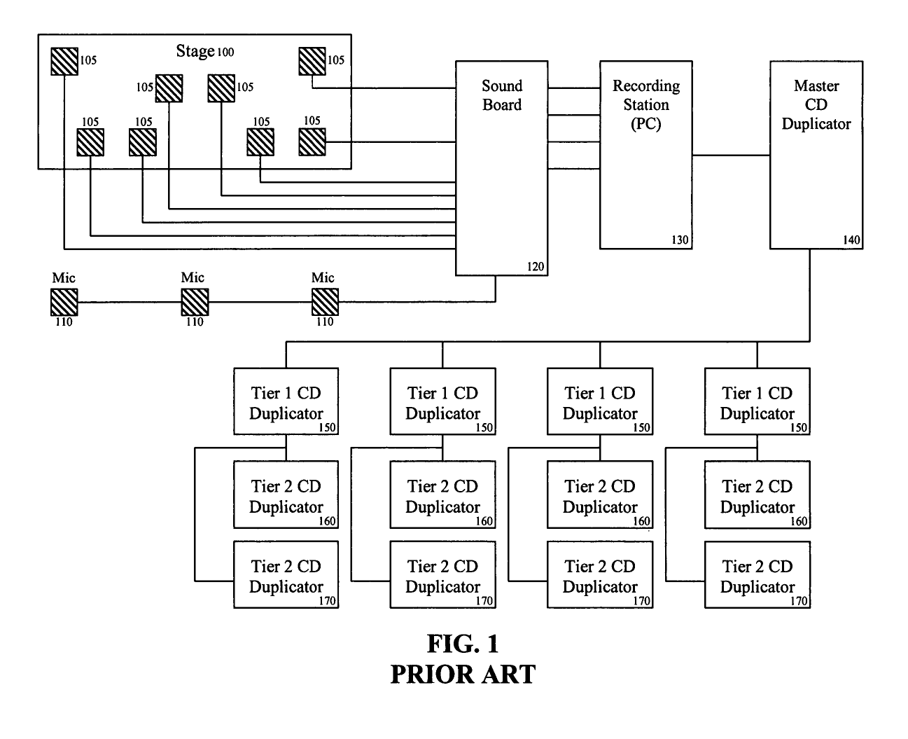

In addition, since the content files are electronically transferred and managed, adding additional duplication equipment allows for rapid production of saleable CDs, rather than increasing the number of optical discs necessary for production and duplication. By contrast, in the conventional production system illustrated in FIG. 1, adding additional duplication equipment increases the time between the end of the event and the first saleable CD being ready.

The present invention also provides an apparatus for recording audio and/or video of an event on a plurality of recordable media that includes a recording station that receives an event signal, a file server and at least one computer. The file server is communicably coupled (e.g., direct connection, wireless connection, optical connection, infrared connection or any other device communication means) to the recording station such that it receives the event signal from the recording station and stores the captured audio and/or video. The least one computer is communicably coupled to the file server and receives a copy of the stored event signal from the file server and records the stored event signal from the at least one computer to the plurality of recordable media.

In addition, the present invention provides a system for recording audio and/or video of an event on a plurality of recordable media that includes a mobile transport unit having a recording station, a file server, and at least one computer therein. Note that the mobile transport unit can be a kit, shipping unit, truck, trailer, vehicle, or other such transport means that allows the system to be transported from one location to another with only a reasonable amount of required assembly or setup. The recording station has an interface to receive an event signal from an outside source. The file server is communicably coupled to the recording station such that it receives the event signal from the recording station and stores the captured audio and/or video. The at least one computer is communicably coupled to the file server such that it receives a copy of the stored event signal from the file server and records the stored event signal from the at least one computer to the plurality of recordable media.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they fall within the spirit and the scope of the invention as described herein.

What is claimed is:

1. A method for recording audio and/or video of an event on a plurality of recordable media, the method comprising the steps of:
receiving an event signal at a recording station;
transferring the event signal from the recording station to a file server, wherein the file server stores the captured audio and/or video;
copying the stored event signal from the file server to at least one computer; and
recording the stored event signal from the at least one computer to the plurality of recordable media.

2. The method of claim 1, further comprising the step of dividing the event signal into separate content files, wherein the separate content files are recorded onto the recordable media as separate files.

3. The method of claim 2, wherein each separate content file is a song or topic.

4. The method of claim 1, further comprising the step of storing the event signal on the at least one computer, wherein event signal may be recorded directly from the at least one computer to the recordable media.

5. The method of claim 2, further comprising the step of providing the amount of separate content files to be recorded on the recordable media, wherein the at least one computer recognizes the number of separate content files that have been copied to the at least one computer.

6. The method of claim 1, wherein the at least one computer has a robotic duplication system attached thereto.

7. The method of claim 1, further comprising the step of defining the number of recordable media to be copied, wherein the at least one computer records only the required number of copies.

8. The method of claim 4, further comprising the step of copying the event signal from the at least one computer to an at least one second computer, wherein the at least one second computer may copy the event signal to the recordable media.

9. The method of claim 1, further comprising the steps of:
instructing the file server that all audio and/or video has been received for the recordable media; and
instructing the at least one computer to begin copying the event signal to the recordable media.

10. The method of claim 1, wherein the recordable media is an optical disc.

11. The method of claim 1, wherein the recordable media is selected from the group consisting of CD-ROM, CD Audio, Enhanced CD, DVD-Audio, DVD-Video, Super Audio CD, and Video CD.

12. A method for recording event data on recordable media, the method comprising the steps of:
receiving a feed of event data to a recording station;
transferring the event data to a file server for storage of the data;
transferring the event data from the file server to at least one duplicator; and
commanding the at least one duplicator to copy the data to the recordable media.

13. The method of claim 12, further comprising the step of converting the data into a .WAV file.

14. The method of claim 12, further comprising the step of dividing the data into at least a first portion and a second portion, wherein at least the first portion is transferred to the file server.

15. The method of claim 12, further comprising the step of checking the quality of the data to be transferred to the at least one duplicator.

16. The method of claim 12, further comprising the step of transferring the data from the at least duplicator to a second at least one duplicator.

17. The method of claim 12, further comprising the step of inputting a number of media to be created.

18. The method of claim 14, further comprising the step of inputting a number of data portions to be copied to the recordable media.

19. An apparatus for recording audio and/or video of an event on a plurality of recordable media comprising:
a recording station that receives an event signal;
a file server communicably coupled to the recording station, the file server receiving the event signal from the recording station and storing the captured audio and/or video; and
at least one computer communicably coupled to the file server, the at least one computer receiving a copy of the stored event signal from the file server and recording the stored event signal from the at least one computer to the plurality of recordable media.

20. A system for recording audio and/or video of an event on a plurality of recordable media comprising:
a mobile transport unit having a recording station, a file server, and at least one computer therein;
the recording station having an interface to receive an event signal from an outside source;
the file server communicably coupled to the recording station, the file server receiving the event signal from the recording station and storing the captured audio and/or video; and
the at least one computer communicably coupled to the file server and receiving a copy of the stored event signal from the file server and recording the stored event signal from the at least one computer to the plurality of recordable media.
